(19) United States
(12) Patent Application Publication
(10) Pub. No.: US 2007/0169107 A1
(43) Pub. Date: Jul. 19, 2007

(54) Method of configuring parameters of machine-to-machine module and machine-to-machine module

(76) Inventor: Sampo Huttunen, Oulu (FI)

Correspondence Address: Hollingsworth & Funk, Suite 125, 8009 34th Avenue South, Minneapolis, MN, 55425, US

(21) Appl. No.: 10/561,643

(22) PCT Filed: Jun. 1, 2004
(86) PCT No.: PCT/FI04/00337

§ 371 Date: Sep. 14, 2006

(30) Foreign Application Priority Data
Jun. 25, 2003 (FI) 20030943

(51) Int. Cl. G06F 9/445

(52) U.S. Cl. 717/174

(57) ABSTRACT

The invention relates to an M2M (machine-to-machine) module and to a method of configuring parameters of an M2M module, the method comprising establishing a connection between the M2M module and a server. The method comprises: downloading, to the M2M module, an application having an application programming interface (API) for configuring the M2M module, the application being configured to run on a Java virtual machine (JVM); communicating with the server by the application for receiving configuration parameters; and setting the parameters of the M2M module by the application based on the received configuration parameters.

### FIELD

The invention relates to a method of configuring parameters of a machine-to-machine (M2M) module and to a machine-to-machine module.

### BACKGROUND

In wireless data communications, machine-to-machine (M2M) solutions are currently being developed. M2M stands for machine-to-machine, mobile-to-machine, and machine-to-mobile. In mobile communications, M2M is about combining telecommunication and information technology; wireless data is used to establish a link between remote devices or locations and systems. By means of M2M solutions, processes can be automated, which in turn increases efficiency, saves costs and provides better service levels. Typically, M2M solutions are created for collecting information, setting parameters, sending indications of unusual situations or taking care of an on-line transaction by means of a wireless data connection. New M2M applications are continuously emerging and they may serve almost any environment (telemetry, telematics, home applications, public traffic service, security and surveillance, telemedicine, sales and payment, service and maintenance, industrial applications and fleet management).

M2M modules/terminals are configured with specific configuration parameters. These parameters may be needed as usage parameters, for example. The parameters may be related to connectivity, such as an address to be connected (for example, IP address or phone number), authentication information, time-out values or bearer information. Nowadays the M2M module configuration is often done by hand and thus, the user enters the parameters into the M2M module, for example. Another possibility of configuring the M2M module is to use smart messages that are communicated between the M2M module and a server that delivers the configuration parameters. The M2M module may, for example, ask for the configuration parameters by sending an SMS (Short Message Service) message through a GSM (Global System for Mobile Communications) system. The server then sends back a smart message including the configuration parameters. It is also possible to configure the M2M module by dedicated configuration software attached physically to the module or by connecting the M2M module to a computer with a cable connection, for example, and executing the configuration by software on the computer.

However, it is typical that the configuration parameters vary from module to module so that different configuration parameters are required for each module. In case there are large module populations, configuration creates problems because in order to configure all the modules, a vast number of smart messages and configuration application parameter settings need to be generated and delivered to the modules, for example. Further, a great amount of work in form of needless visits to the modules, for example, is required to configure the modules correctly.

### BRIEF DESCRIPTION OF THE INVENTION

An object of the invention is to provide an improved method of configuring parameters of an M2M module and an improved M2M module. An aspect of the invention provides a method of configuring parameters of an M2M (machine-to-machine) module, the method comprising establishing a connection between the M2M module and a server. The method of the invention comprises: downloading, to the M2M module, an application having an interface for configuring the M2M module, the application being configured to run on a Java virtual machine (JVM); communicating with the server by the application for receiving configuration parameters; and setting the parameters of the M2M module by the application based on the received configuration parameters.

According to another aspect of the invention, there is provided an M2M (machine-to-machine) module, comprising: means for operating a Java virtual machine and means for establishing a connection between the M2M module and a server. The M2M module of the invention is configured to: download an application having an application programming interface (API) for configuring the M2M module, the application being configured to run on a Java virtual machine (JVM); communicate with the server by the application for receiving configuration parameters; and set the parameters of the M2M module by the application based on the received configuration parameters.

Preferred embodiments of the invention are described in the dependent claims.

The method and system of the invention provide several advantages. There is no need for manual configuration of the M2M modules. Also, automated configuration of a large module population becomes possible. In a preferred embodiment of the invention, there is no need to generate different smart messages or applications or different application parameter settings for each individual module. The invention provides a centralized module configuration, in which a large module population is configured consistently or individually depending on the configuration needs, becomes possible.

### LIST OF DRAWINGS

In the following, the invention will be described in greater detail with reference to the preferred embodiments and the accompanying drawings, in which

FIG. 1 shows an example of a structure of a radio system;

FIG. 2 illustrates a more detailed example of an M2M module in a radio system; and

FIG. 3 is a signal sequence diagram illustrating the method of configuring parameters of an M2M module in a radio system.

### DESCRIPTION OF EMBODIMENTS

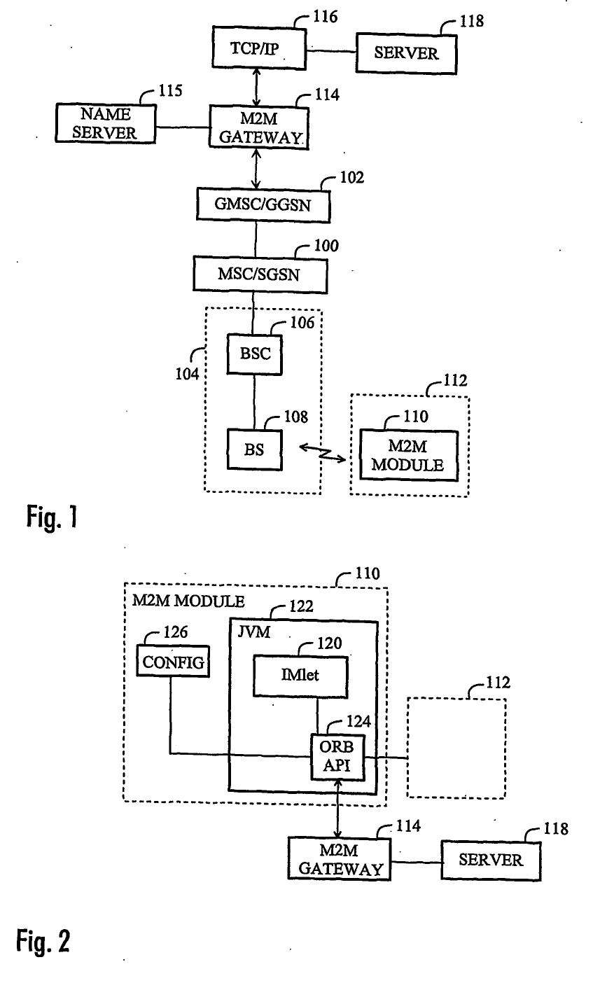

With reference to FIG. 1, examine an example of a radio system in which the preferred embodiments of the invention can be applied. The radio system can be based on, for example, GSM (Global System for Mobile Communications) or WCDMA (Wide-band Code Division Multiple Access).

The core network may correspond to the combined structure of the GSM (Global System for Mobile Communications) and GPRS (General Packet Radio Service) systems, for example. The GSM network elements are responsible for the implementation of circuit-switched connections, and the GPRS network elements are responsible for the implementation of packet-switched connections, some of the network elements, however, being shared by both systems.

A centre 100 represents a mobile services switching centre (MSC) and a serving GPRS support node (SGSN) that enable circuit-switched and packet switched signalling, respectively, in the radio system. Because the centre 100 can control all the traffic in the radio system, the centre 100 can gather accounting information of each user, which accounting information may be used in billing.

A core network may comprise a gateway unit 102, which is represented by a gateway mobile service switching centre (GMSC) and a gateway GPRS support node (GGSN). The GMSC attends to the circuit-switched connections between the core network and external networks, such as a public land mobile network (PLMN) or a public switched telephone network (PSTN), and the GGSN attends to the packet-switched connections between the core network and external networks, such as the Internet.

The centre 100 controls a radio access network (RAN) 104, which may comprise at least one base station controller 106 controlling at least one base station 108. The base station controller 106 can also be called a radio network controller, and the base station 108 can be called node B.

An M2M module 110 communicates with at least one base station 108 over a radio interface. The M2M module 110 comprises an interface for connecting to a remote device 112, for example. The M2M module 110 may also comprise a built-in SIM (Subscriber Identity Module) and an internal antenna. The remote device 112 may be a vending machine or an elevator, for example. Further, the remote device 112 may be any device that is related to security, automatic meter reading, industrial applications, cargo tracking, road traffic information, traffic control systems or telemedicine, for example.

An M2M gateway 114 is a middleware for establishing wireless machine-to-machine applications. The M2M gateway 114 is used for bridging the GSM network and the Internet, for example, by providing a connection for two-way communication between applications located on a server 118 and within one or more remote devices 112. The M2M gateway 114 is based on open, widely accepted middleware and communication architecture CORBA (Common Object Request Broker Architecture).

A server 118 may communicate with the radio system over a TCP/IP (transmission control protocol/Internet protocol) 116, for example. The server 118 may be located on the Internet or in a company Intranet, for example. The server 118 is used for controlling the remote devices 112 in the radio system. If the remote device 112 is a vending machine, for example, then the company that maintains the vending machines may control the server 118. The M2M module 110 is used to communicate information between the server 118 and the remote device 112 and also to execute instructions given by the server 118, for example. For example, data about the number of product items present in the remote device 112 may be transferred to the server 118. The server 118 in turn may send control commands to the remote device 112 in order to get the data it needs or to modify the settings of the device, for example.

The M2M gateway 114 may communicate with a name server 115. The name server 115 is, for example, a CORBA name server that provides parameters on how to make method calls to the server 118 over the TCP/IP-connection or to the M2M module 110.

The present solution is generally described in FIG. 2. The M2M module 110 in FIG. 2 comprises a Java virtual machine (JVM) 122, which is an abstract computer that provides an interface between a compiled Java binary code and the platform which actually performs the program instructions. In Java programming environments, there are application programs 120, such as applets, MIDlets and IMlets. The application program 120 is a small program designed to perform specific functions. Applications 120 use the services of the module's operating system and other supporting applications. The means of communicating with other programs that the application 120 program uses is called the application program interface (API) 124.

Wireless Java applications rely on Java 2 Platform, Micro Edition (J2ME), for example. The J2ME architecture defines configurations, profiles and optional packages as elements for building Java environments that meet the requirements for a broad range of different devices. The configurations are composed of a virtual machine and a minimal set of class libraries. With the J2ME, applications are written once for a wide range of devices and can be downloaded dynamically. The J2ME applications are small programs that can be downloaded to the M2M module 110 and then be executed in it.

A J2ME application 120 implemented using an IM Profile, for example, is referred to as the IMlet, and it provides the user interface on the module. The J2ME application 120 communicates with a Java servlet, for example, usually via HTTP, and over a secure channel when necessary. The servlet interprets requests from the J2ME application 120, and in turn, dispatches client requests to EJB (Enterprise Java Beans architecture) components, for example. The IM Profile specification provides a mechanism for J2ME applications 120 to persist and retrieve data. This storage mechanism, called Record Management System (RMS), is a simple, record-oriented database. Each record is stored and retrieved as an array of bytes. J2ME applications 120 may add, retrieve, and remove records from an RMS record store.

In an embodiment of the invention, an application 120, such as an IMlet, having an application-programming interface (API) for configuring the M2M module, is downloaded to the M2M module 110, the application running on a Java virtual machine (JVM) 122. The downloaded application 120 communicates with the radio system using a method call through CORBA API 124, for example, in order to receive configuration parameters from the server 118. The application 120 may also communicate over a TCP/IP socket, for example. The parameters of the M2M module 110 are set by the application 120 based on the received configuration parameters.

The application 120 is downloaded to the M2M module 110, to the Java virtual machine 122 over a cable, over an infrared connection or over-the-air (OTA), for example. Over-the-air downloading may also be initiated from outside of the M2M module 110, that is, from the M2M gateway 114 side. The application 120 may be triggered to run immediately after it has been downloaded to the M2M module 110, for example. Thus, the M2M module's 110 connection parameters may be fully configured by using the application 120 even if the M2M module 110 has not been configured at all after factory settings.

In an embodiment of the invention, the application 120 is a Java 2 Micro Edition (J2ME™) application, such as a Java MIDlet or a Java IMlet. The application-programming interface 124 may be provided by, for example, an ORB API (object request broker API), that is, a basic mechanism for making requests to and receiving responses from objects located locally or remotely. The ORB establishes the client-server relationship between objects. For example, the CORBA is a standardised ORB architecture.

The application 120 may comprise different communication channels, such as I/O API, to communicate via the M2M module 110 pins, SMS API to provide SMS message communication with the GSM network, ORB API to communicate with the M2M gateway, a module ORB or an AM ORB and a CLDC (Connected Limited Device Configuration) API to be used with byte stream to socket connections, serial protocol to serial port connections and HTTP (hypertext transfer protocol) connections.

The M2M module 110 comprises a configuration block 126, in which the application 120 sets the parameters to be configured, for example. The parameters to be configured may include usage parameters, such as passwords, user names, default connection settings, gateway parameters, IP-addresses, used bit rates, connection time-outs or idle times, for example.

The M2M module 110 may comprise an interface to connect to a remote device 112, such as a vending machine or an electricity meter reader, for example. The remote device 112 may then comprise an ORB (object request broker) module, such as an AM (Application Module) ORB for communicating with the M2M module 110.

In a case where the remote device 112 is, for example, an electricity meter reader, it is feasible that the electricity meter reader should be checked several times a year, for example. It is possible that the readings of the electricity meter reader are sent periodically to the server 118 of the electric company, for example. However, if the electric company wishes to change the meter reading periods, it is possible to configure the parameters that control these periods by using the described example of the method of the invention. Thus, also an automated configuration of a large module population becomes possible without the need to generate different J2ME applications 120 for each individual M2M module 110.

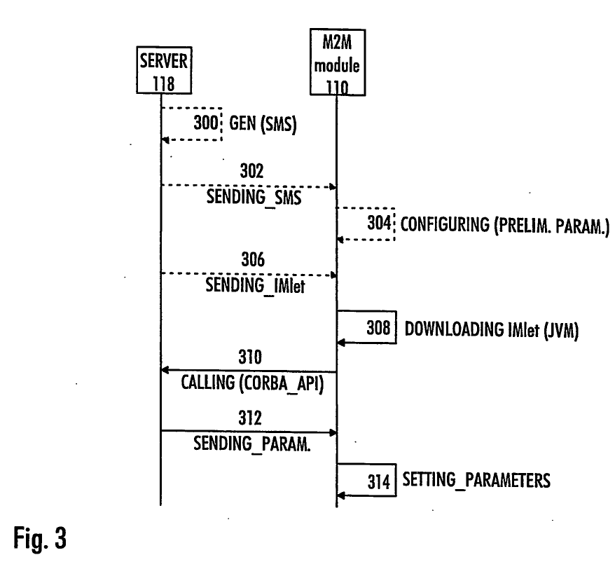

Let us next study the example of FIG. 3 of a method of configuring parameters of an M2M module. In FIG. 3, the first vertical line SERVER 118 denotes communication originating from and terminating in a server, the server being in a company Intranet or Internet, for example. The second vertical line M2M module 110 denotes communication of the M2M module and measures taken by the M2M module. The lines illustrated with dashed lines show optional steps of the method.

This example illustrates a situation where a new M2M module 110 with no J2ME application for configuring the M2M module is taken to use. In 300, in the server 118, a SMS message is generated, the SMS message comprising preliminary parameters for configuring the M2M module. Such parameters may be parameters needed for establishing GPRS connections to the direction of the M2M gateway, for example. Next in 302, the generated SMS message comprising the preliminary parameters is sent from the server 118 to the M2M module 110. In 304, the M2M module 110 configures the preliminary parameters that have been received with the SMS message. After the preliminary parameters have been configured in the M2M module, then, in 306, the server 118 is able to establish a CORBA connection between the server 118 and the M2M module 110 and to send a J2ME application to the M2M module 110 by the CORBA connection. The J2ME application is called in this example an IMlet.

In 108, the IMlet is downloaded to the M2M module 110 over the CORBA connection. The IMlet can be downloaded in other ways to the M2M module as well, such as over a cable from a computer or over an infrared connection, for example. Once the IMlet has been downloaded to the Java virtual machine operating in the M2M module, it can be used to configure parameters of the M2M module. It is also feasible that the IMlet has already been downloaded at the manufacturing stage. Thus, the method of this example may start in 310.

In 310, the IMlet makes a CORBA method call through a CORBA API to the server 118 in order to receive configuration parameters. Thus, the IMlet communicates with an application on the server behind the M2M gateway by using CORBA messages. The IMlet may, for example, include a reference to a remote object on the server application. The object reference has a stub method, which is a stand-in for the method being called remotely. The stub is wired into the ORB in a way that the calling of it invokes the ORB's connection capabilities and forwards the invocation to the server. On the server, the ORB uses a skeleton code to translate the remote invocation into a method call on the local object. The skeleton translates the call and any parameters and calls the method being invoked. When the method returns, the skeleton code transforms the results and sends them back to the IMlet via the ORBs. Between the ORBs, communication proceeds by means of a shared protocol, which is based on the standard TCP/IP Internet protocol. The IMlet may also communicate with the server 118 over TCP/IP connections, for example. Thus, the IMlet establishes a TCP/IP socket to a given IP address or a port and uses, for example, a HTTP protocol for downloading the required configuration parameters.

In 312, the configuration parameters are sent from the server 118 to the IMlet. Then, in 314, the IMlet sets the parameters of the M2M module based on the received configuration parameters.

It is possible that, when in 306 the server 118 is sending the IMlet to the M2M terminal 110, the required configuration parameters at that time are sent at the same time to the M2M terminal 110 with the IMlet.

If the IMlet, in 308, is downloaded to the M2M module 110 at the manufacturing stage, then some or all of the M2M modules used in remote devices, for example, may have similar IMlets downloaded to each of them. Thus, as the M2M module is set to work, the IMlet may automatically establish a connection to the server 118. Then, the IMlet may use the CORBA method call or a TCP/IP connection for establishing the connection to the server 118.

In an embodiment, it is also possible that the server 118 initiates the configuration of the parameters by sending a control command comprising the configuration parameters to the IMlet through the M2M gateway. There may be a need to change some settings of the remote device in connection with the M2M module, for example, and the IMlet may be used to configure these settings of the remote device based on the configuration parameters sent from theserver to the IMlet.

Even though the invention is described above with reference to an example according to the accompanying drawings, it is clear that the invention is not restricted thereto but it can be modified in several ways within the scope of the appended claims.

1. A method of configuring parameters of an M2M (machine-to-machine) module, the method comprising establishing a connection between the M2M module and a server, characterized by the method comprising:
(304) downloading, to the M2M module, an application having an interface for configuring the M2M module, the application being configured to run on a Java virtual machine (JVM);
(306, 308) communicating with the server by the application for receiving configuration parameters; and
(310) setting the parameters of the M2M module by the application based on the received configuration parameters.

2. The method of claim 1, characterized in that the connection between the M2M module and the server is established through a M2M gateway or over a TCP/IP connection.

3. The method of claim 1, characterized in that the communicating with the server comprises: requesting (306) configuration parameters from the server and receiving (308), in the application, the configuration parameters from the server.

4. The method of claim 1, characterized by the application being a Java 2 Micro Edition (J2ME™) application.

5. The method of claim 3, characterized by the application being a Java MIDlet or a Java IMlet.

6. The method of claim 1, characterized by the application being downloaded to the M2M module over a cable, over an infrared connection or over-the-air (OTA).

7. The method of claim 1, characterized by the application programming interface being a Common Object Request Broker Architecture (CORBA) API.

8. The method of claim 6, characterized by communicating with the server by making a method call through the CORBA API.

9. The method of claim 1, characterized by using the M2M module (110) for configuring parameters of a remote device based on the configuration parameters received from the server.

10. An M2M (machine-to-machine) module (110), comprising:
means for operating a Java virtual machine (122) and means (124) for establishing a connection between the M2M module (110) and a server (118), characterized by the M2M module (110) being configured to:
download an application (120) having an application programming interface (API) (124) for configuring the M2M module, the application (120) being configured to run on a Java virtual machine (JVM) (122);
communicate with the server (118) by the application (120) for receiving configuration parameters; and
set the parameters of the M2M module (110) by the application (120) based on the received configuration parameters.

11. The M2M module of claim 10, characterized in that the M2M module (110) is further configured to request, by the application, configuration parameters from the server (118) and receiving, in the application, the configuration parameters from the server (118).

12. The M2M module of claim 10, characterized in that the application (120) is a Java 2 Micro Edition (J2ME™) application.

13. The M2M module of claim 10, characterized in that the application (120) is a Java MIDlet or a Java IMlet.

14. The M2M module of claim 10, characterized in that the M2M module (110) is configured to download the application (120) over a cable, over an infrared connection or over-the-air (OTA).

15. The M2M module of claim 10, characterized in that the application-programming interface (124) is a Common Object Request Broker Architecture (CORBA) API.

16. The M2M module of claim 15, characterized in that the M2M module (110) is configured to communicate with the server (118) by making a method call through the CORBA API (124).

17. The M2M module of claim 10, characterized in that the M2M module (110) is used for configuring parameters of a remote device (112) based on the configuration parameters received from the server (118).
